(19) United States
(12) Patent Application Publication
(10) Pub. No.: US 2026/0158799 A1
(43) Pub. Date: Jun. 11, 2026

(54) SHEET DRYING APPARATUS AND IMAGE FORMING SYSTEM PROVIDED THEREWITH

(71) Applicant: KYOCERA Document Solutions Inc., Osaka (JP)

(72) Inventor: Yuichiro KUROKAWA, Osaka (JP)

(73) Assignee: KYOCERA Document Solutions Inc., Osaka (JP)

(21) Appl. No.: 19/400,574

(22) Filed: Nov. 25, 2025

(30) Foreign Application Priority Data
Dec. 5, 2024 (JP) 2024-212535

(51) Int. Cl. B41J 11/00; B41J 29/377

(52) U.S. Cl. CPC B41J 11/00242; B41J 11/006; B41J 29/377

(57) ABSTRACT

A sheet drying apparatus includes a conveyance portion, a drying portion, and a control portion. The conveyance portion conveys a sheet on which an image has been formed with ink containing moisture. The drying portion includes a heating unit that can be raised and lowered between a heating position for heating the sheet with a heater and a retracted position, and a unit ascent-descent mechanism that raises and lowers the heating unit. When a jam of the sheet is detected between the conveyance portion and the heating unit, the control portion turns off the supply of power to the heater, stops the conveyance portion, arranges the heating unit at the heating position until the temperature in the heating unit falls below a first temperature, and, after the temperature in the heating unit falls below the first temperature, raises the heating unit from the heating position to the retraction position.

### INCORPORATION BY REFERENCE

This application is based on and claims the benefit of priority from Japanese Patent Application No. 2024-212535 filed on Dec. 5, 2024, the contents of which are hereby incorporated by reference.

### BACKGROUND

The present disclosure relates to a sheet drying apparatus that dries sheets on which images have been printed in an inkjet recording apparatus or the like, and to an image forming system provided with such a sheet drying apparatus.

As recording apparatuses such as facsimile machines, copiers, and printers, inkjet recording apparatuses, which form images by ejecting ink onto a sheet, are widely used. Sheet drying apparatuses are known for heating and drying sheets (paper) on which ink has been adhered by inkjet recording apparatuses.

In a sheet drying apparatus, if a jam of a sheet (stuck paper) occurs near a drying portion, it is necessary to turn off the power to a heating unit and to widen the gap (drying space) between the heating unit and a conveyance portion to remove the jammed sheet. However, even after the power to the heating unit is turned off, hot air remains in the drying space. Thus, if the drying space is widened immediately after the heating unit is turned off, the hot air may disperse inside the sheet drying apparatus and electronic components such as a sheet detection sensor arranged near the drying portion may deteriorate due to heat.

### SUMMARY

According to one aspect of the present disclosure, a sheet drying apparatus includes a conveyance portion, a drying portion, and a control portion. The conveyance portion conveys a sheet on which an image has been formed with ink containing moisture. The drying portion is arranged opposite the conveyance portion and heats and dries the sheet. The control portion controls the conveyance portion and the drying portion. The drying portion includes a heating unit and a unit ascent-descent mechanism. The heating unit has a heater for heating the sheet, and it can be raised and lowered between a heating position in which the heating unit heats the sheet with the heater and a retracted position in which the heating unit is arranged away from the conveyance portion. The unit ascent-descent mechanism raises and lowers the heating unit. When a jam of the sheet is detected between the conveyance portion and the heating unit, the control portion turns off the supply of power to the heater, stops the conveyance portion, arranges the heating unit at the heating position until the temperature in the heating unit falls below a first temperature, and, after the temperature in the heating unit falls below the first temperature, raises the heating unit from the heating position to the retraction position.

### BRIEF DESCRIPTION OF THE DRAWINGS

FIG. 1 is a schematic diagram showing the internal construction of an image forming system including a sheet drying apparatus of the present disclosure.

FIG. 2 is a side sectional view around a drying portion in a sheet drying apparatus according to one embodiment of the present disclosure.

FIG. 3 is an enlarged view of the drying portion in FIG. 2.

FIG. 4 is a block diagram showing one example of control paths in the sheet drying apparatus.

FIG. 5 is a side sectional view showing a state in which a sheet has jammed in the drying portion in the sheet drying apparatus.

FIG. 6 is a diagram showing a state in which a heating unit has been raised from the state in FIG. 5.

FIG. 7 is a flow chart showing an example of control including the operation of raising the heating unit when a sheet has jammed around the drying portion.

### DETAILED DESCRIPTION

### 1. Construction of an Image Forming System Including a Sheet Drying Apparatus

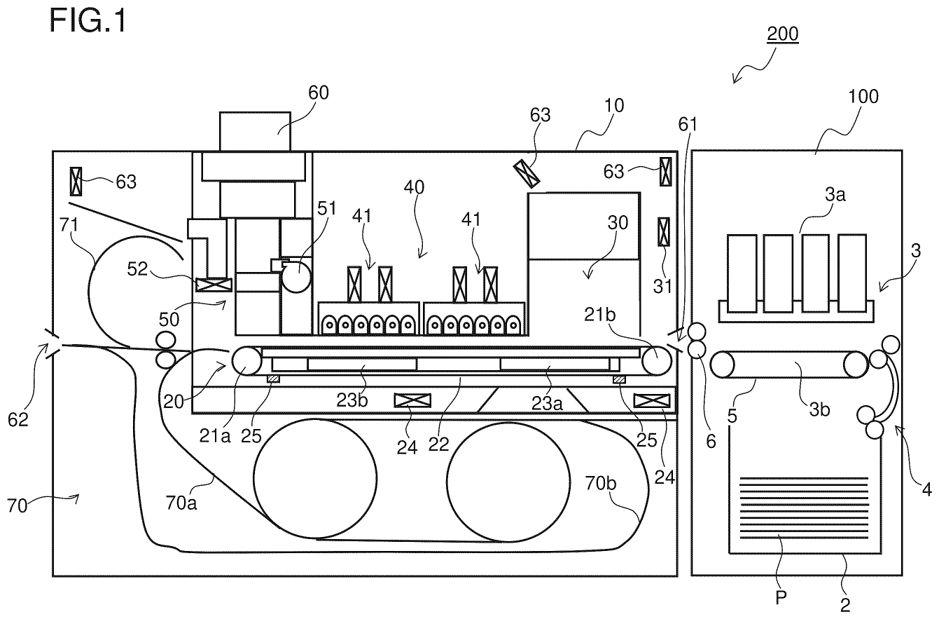

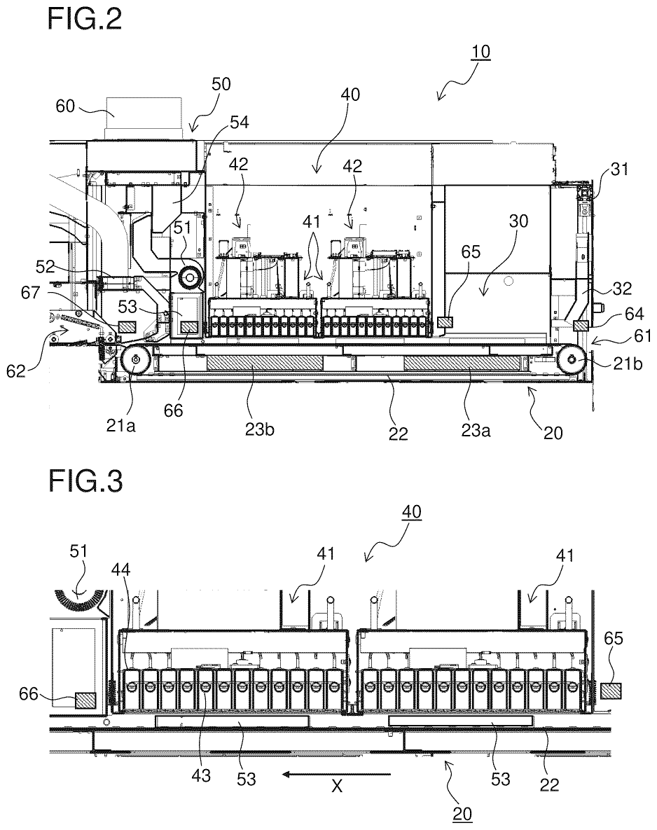

An embodiment of the present disclosure will be described below with reference to the accompanying drawings. FIG. 1 is a schematic diagram showing the internal construction of an image forming system 200 including a sheet drying apparatus 10 of the present disclosure. FIG. 2 is a side sectional view around a drying portion 40 in the sheet drying apparatus 10 according to one embodiment of the present disclosure. The image forming system 200 configured with an image forming apparatus 100 and the sheet drying apparatus 10 will be described with reference to FIGS. 1 and 2.

The image forming apparatus 100 is an inkjet recording printer and includes a sheet storage portion 2 arranged in a bottom part of the image forming apparatus 100, an image forming portion 3 arranged above the sheet storage portion 2, and a sheet feed portion 4 that feeds a sheet P stored in the sheet storage portion 2 to the image forming portion 3.

The image forming portion 3 is configured with a recording portion 3a having a plurality of recording heads and a print conveyance portion 3b arranged opposite the recording portion 3a. The print conveyance portion 3b includes an endless print conveyance belt 5 stretched around a plurality of rollers including a driving roller. The sheet P conveyed by the sheet feed portion 4 is conveyed below the recording portion 3a by being held under suction on the print conveyance belt 5 by a sheet suction portion (not shown) arranged inward of the print conveyance belt 5. The sheet P having a predetermined image recorded to it by the image forming portion 3 is discharged through a pair of discharge rollers 6 and is conveyed into the sheet drying apparatus 10.

The sheet drying apparatus 10 is arranged adjacent to the image forming apparatus 100 and dries the ink on the sheet P discharged from the image forming apparatus 100. The sheet drying apparatus 10 includes a first conveyance portion 20, a preliminary drying portion 30, a drying portion 40, a suction fan unit 50, and a second conveyance portion 70.

The first conveyance portion 20 includes a driving roller 21a, a driven roller 21b, and a conveyance belt 22. The conveyance belt 22 is stretched around the driving roller 21a arranged on the downstream side and the driven roller 21b arranged on the upstream side with respect to the conveyance direction of the sheet P (right to left direction in FIG. 1; hereinafter, referred to simply as the conveyance direction).

Inward of the conveyance belt 22 is arranged sheet suction portions 23a and 23b. In the conveyance belt 22, many suction holes (not shown) are formed through which to pass suction air for sucking the sheet P onto the conveyance belt 22 by negative pressure suction by the sheet suction portions 23a and 23b.

Belt cooling fans 24 are arranged at two places below the conveyance belt 22. A belt temperature sensor 25 is arranged adjacent to a bottom face of the conveyance belt 22. The belt cooling fans 24 blow cooling air to the conveyance belt 22 when the sensed temperature of the belt temperature sensor 25 reaches or exceeds a predetermined temperature.

The preliminary drying portion 30 is arranged closely downstream of a sheet introduction port 61 with respect to the conveyance direction and preliminarily dries the ink on the sheet P conveyed in through the sheet introduction port 61. The preliminary drying portion 30 includes a sheet blowing fan 31 and a sheet blowing duct 32 for blowing air from above the sheet P.

The drying portion 40 is arranged adjacently downstream of the preliminary drying portion 30 with respect to the conveyance direction and dries the ink on the sheet P having passed through the preliminary drying portion 30. The drying portion 40 includes two heating units 41 arranged opposite a top surface of the conveyance belt 22.

The suction fan unit 50 sucks in the water vapor emanating from the sheet P passing through the drying portion 40. The suction fan unit 50 includes a suction fan 51 that sucks in air containing water vapor inside the drying portion 40 and a separation fan 52 that blows separation air for separating the sheet P from the conveyance belt 22. The suction fan unit 50 communicates with a space (drying space) between the conveyance belt 22 and the heating unit 41 via a first duct 53 and communicates with an exhausting port 60 formed in a top part of the sheet drying apparatus 10 via a second duct 54.

A plurality of ambient air intake fans 63 for taking in ambient air into the sheet drying apparatus 10 are arranged at appropriate places in the sheet drying apparatus 10. In an upstream part of the first conveyance portion 20 are arranged a first sheet detection sensor 64 and a second sheet detection sensor 65. In a downstream part of the first conveyance portion 20 are arranged a third sheet detection sensor 66 and a fourth sheet detection sensor 67. The first to fourth sheet detection sensors 64 to 67 are, for example, PI (photo interrupter) sensors that detect the sheet P passing through.

As, by being driven to rotate by the driving roller 21a, the conveyance belt 22 rotates in the counterclockwise direction, the sheet P conveyed in through the sheet introduction port 61 passes through the preliminary drying portion 30 and then through the drying portion 40 to be discharged through the sheet discharge port 62 out of the sheet drying apparatus 10 or conveyed into the second conveyance portion 70.

The second conveyance portion 70 is arranged below the drying portion 40 and the preliminary drying portion 30 across the first conveyance portion 20. The second conveyance portion 70 includes a reversing conveyance passage 70a, for reversing top side down the sheet P on which the ink has been dried, and a duplex conveyance passage 70b, for returning, when duplex printing is performed on the sheet P, the sheet P reversed top side down to the image forming apparatus 100.

Downstream (left side in FIG. 1) of the suction fan unit 50 with respect to the conveyance direction is provided a retraction path 71 in the shape of an arc. The retraction path 71 is where a sheet P (waste sheet) that has become useless due to a printing defect or the like in the image forming apparatus 100 is retracted and stored.

### 2. Construction of the Drying Portion of the Sheet Drying Apparatus

FIG. 3 is an enlarged view of the drying portion 40 in FIG. 2. The drying portion 40 includes a heating unit 41 and a hot air fan 42 (see FIG. 2). Two heating units 41 are arranged along the conveyance direction (arrow-X direction). The heating unit 41 includes a heater 43 and a reflector 44. The heating unit 41 is movable between a heating position (the position in FIG. 3) facing the conveyance belt 22 and a retracted position (see FIG. 10) away from the conveyance belt 22.

The heater 43 is in the shape of a bar extending in the sheet width direction (the direction orthogonal to the plane in FIG. 3; hereinafter, referred to simply as the width direction) horizontally orthogonal to the conveyance direction. In the heating unit 41, a plurality (12 in this embodiment) of heaters 43 are arranged side by side along the conveyance direction. In this embodiment, an infrared heater is used as the heater 43.

The reflector 44 is a reflector plate U-shaped as seen in a side view arranged so as to surround the heater 43 from above. The infrared rays emitted from the heater 43 are reflected downward by the inner surface of the reflector 44 and are shone onto the sheet P carried and conveyed on the conveyance belt 22. Thus, the moisture in the ink on the sheet P evaporates and the ink dries; thus, the ink is fixed to the sheet P.

The hot air fan 42 is arranged above the heating unit 41. More specifically, the hot air fan 42 is arranged so as to blow air from above toward the reflectors 44. The air blown from the hot air fan 42 onto the reflectors 44 is heated as it passes through the gaps between the reflectors 44 become hot air to flow into the gap (drying space) between the heating unit 41 and the conveyance belt 22.

If steam or water vapor is present in the gap between the heating unit 41 and the conveyance belt 22, the infrared rays emitted from the heater 43 and reflected from the reflector 44 are absorbed by the steam or water vapor and this impairs their ability to dry the ink on the sheet P. Thus, by operating the hot air fan 42 to blow hot air into the gap between the heating unit 41 and the conveyance belt 22 and scattering and removing the steam or water vapor emanating from the sheet P, it is possible to maintain the drying properties of the ink under infrared rays.

Between the drying portion 40 and the suction fan unit 50, a first duct 53 is provided for sucking the steam or water vapor emanating from the sheet P together with air. The first duct 53 extends from the gap between the heating unit 41 and the conveyance belt 22 to the suction fan 51 in the suction fan unit 50.

### 3. Control Paths of the Sheet Drying Apparatus

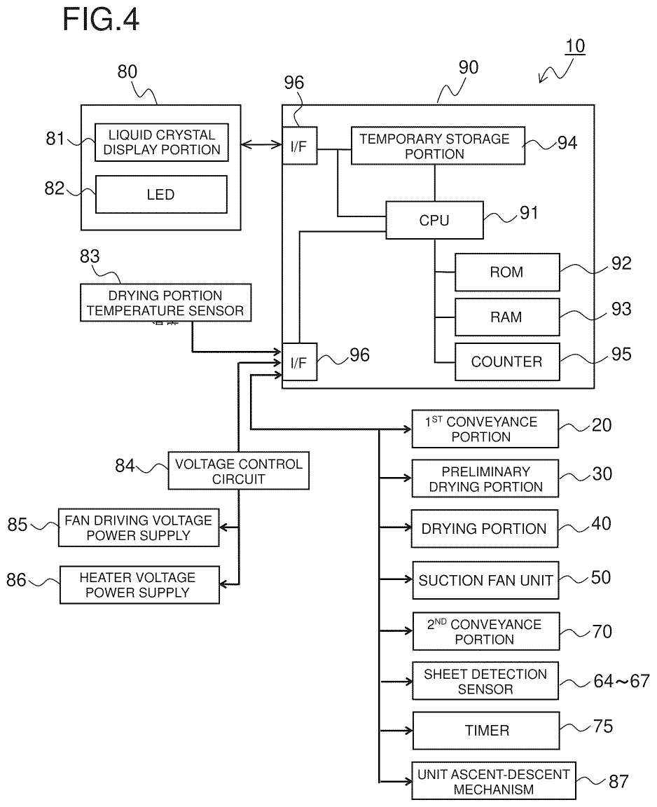

FIG. 4 is a block diagram showing one example of control paths in the sheet drying apparatus 10 of this embodiment. For simplicity's sake, the following description will focus on those control paths in the sheet drying apparatus 10 that are necessary for implementing the present disclosure.

A control portion 90 at least includes a CPU (central processing unit) 91 as a central arithmetic processor, a ROM (read-only memory) 92 as a read-only storage portion, a RAM (random-access memory) 93 as a readable and rewritable storage portion, a temporary storage portion 94 that temporarily stores data required for controlling different parts of the sheet drying apparatus 10, and a plurality of (here, two) I/Fs (interfaces) 96 that transmit control signals to different blocks in the sheet drying apparatus 10 and receive input signals from an operation portion 80.

The ROM 92 stores a control program for the sheet drying apparatus 10 as well as data that is not changed during the use of the sheet drying apparatus 10, such as values necessary for control. The RAM 93 stores necessary data generated in controlling the sheet drying apparatus 10, data temporarily required in controlling the sheet drying apparatus 10, and the like. The RAM 93 (or the ROM 92) also stores, for use in ascent-descent control for the heating unit 41 on occurrence of a jam, the standby time required for the heating unit 41 to cool down to a predetermined temperature. The counter 95 counts the cumulative number of sheets P that have been conveyed.

The control portion 90 transmits control signals from the CPU 91 via the I/Fs 96 to different parts and blocks in the sheet drying apparatus 10. From those parts and blocks, signals indicating their states and input signals are transmitted via the I/Fs 96 to the CPU 91. Examples of the parts and blocks controlled by the control portion 90 include the first conveyance portion 20, the preliminary drying portion 30, the drying portion 40, the suction fan unit 50, the second conveyance portion 70, the operation portion 80, a unit ascent-descent mechanism 87, and the like.

A voltage control circuit 84 is connected to a fan driving voltage power supply 85 and to a heater voltage power supply 86 and, according to output signals from the control portion 90, operates these power supplies. According to control signals from the voltage control circuit 84, the fan driving voltage power supply 85 applies a predetermined voltage to the hot air fan 42 and the heater voltage power supply 86 applies a predetermined voltage to the heater 43 in the heating unit 41.

The operation portion 80 includes a liquid crystal display portion 81 and LEDs 82 that indicate various states. A user operates a stop/clear button on the operation portion 80 to stop the drying of the sheet P and operates a reset button on it to bring various settings for the sheet drying apparatus 10 to default ones. The liquid crystal display portion 81 indicates the status of the sheet drying apparatus 10 and displays the progress of the drying of the sheet P and the number of sheets P that have been introduced. Various settings for the sheet drying apparatus 10 may be made via an input portion 101 on the image forming apparatus 100.

A drying portion temperature sensor 83 senses the temperature in the space (drying space) between the heating unit 41 and the conveyance belt 22. The result of the sensing is transmitted to the control portion 90.

The unit ascent-descent mechanism 87 moves the heating unit 41 in the drying portion 40 between the heating position (see FIG. 3) and the retracted position (see FIG. 6). The unit ascent-descent mechanism 87 is configured with, for example, a conventionally known driving mechanism such as a rack and pinion mechanism or a wind-up pulley and a wire.

### 4. Control for Jam Removal Around the Drying Portion of the Sheet Drying Apparatus

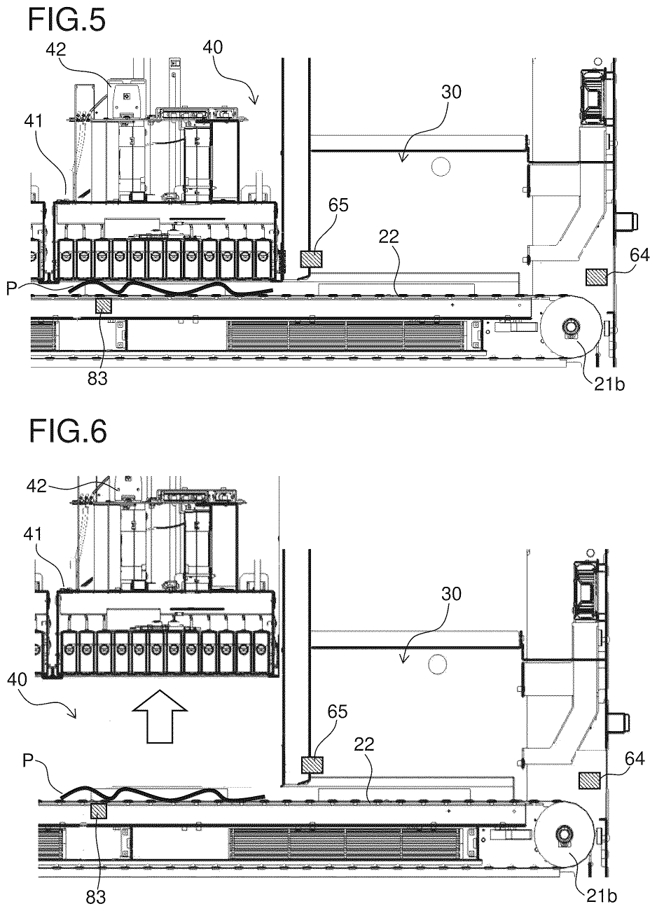

FIG. 5 is a side sectional view showing a state in which a sheet P has jammed in the drying portion 40 in the sheet drying apparatus 10. As shown in FIG. 5, if a sheet P jams between the heating portion 41 in the drying portion 40 and the conveyance belt 22, the sheet P does not reach the third sheet detection sensor 66. Thus, after the sheet P passes across the second sheet detection sensor 65, if at the lapse of a predetermined period of time the sheet P is not detected by the third sheet detection sensor 66, a jam is judged to have occurred around the drying portion 40.

If a sheet P jams with its trailing end facing the second sheet detection sensor 65 or with its leading end facing the third sheet detection sensor 66, the second sheet detection sensor 65 or the third sheet detection sensor 66 stays in a detecting state. If the second sheet detection sensor 65 or the third sheet detection sensor 66 stays in the detecting state for a predetermined time or longer, it is judged that a jam has occurred around the drying portion 40.

If it is judged that a jam has occurred around the drying portion 40, the control portion 90 turns off the supply of power from the heater voltage power supply 86 to the heater 43. Then, to perform jam removal for the sheet P, the heating unit 41 is raised using the unit ascent-decent mechanism 87.

FIG. 6 is a diagram showing a state in which the heating unit 41 has been raised to the retracted position from the state in FIG. 5. As shown in FIG. 6, making the unit ascent-decent mechanism 87 raise the heating unit 41 from the heating position to the retraction position allows removal of the jammed sheet P.

However, even when the supply of power to the heater 43 is turned off, the temperature of the heating unit 41 does not fall immediately. Thus, if the heating unit 41 is raised immediately after the supply of power to the heater 43 is turned off, the hot air present between the heating unit 41 and the conveyance belt 22 disperses inside the sheet drying apparatus 10. As a result, electronic components such as the second sheet detection sensor 65 and the third sheet detection sensor 66 located near the drying portion 40 deteriorate due to heat.

To cope with that, in this embodiment, if a jam of a sheet P occurs around the drying portion 40, after the power supplied to the heater 43 is turned off, the heating unit 41 is kept on standby at the heating position until the temperature in the heating unit 41 falls below a predetermined temperature (a first temperature). Then, after the temperature in the heating unit 41 falls below the predetermined temperature, the heating unit 41 is raised to the retraction position.

This prevents the hot air present between the heating unit 41 and the conveyance belt 22 disperse inside the sheet drying apparatus 10. The first temperature is set to a temperature (for example, 80° C.) below which the electronic components such as the second sheet detection sensor 65 and the third sheet detection sensor 66 do not deteriorate due to heat.

Jam removal is allowed not immediately after the heating unit 41 is raised to the retraction position; it is when the temperature in the drying space between the heating unit 41 and the conveyance belt 22 falls below a predetermined temperature (a second temperature) lower than the first temperature that a jam removal enabled state is established. This prevents the user from inserting his or her hand into the hot drying space when performing jam removal. The second temperature is set to a temperature (for example, 40° C.) below which the user will not suffer a burn when inserting his or her hand into the drying space.

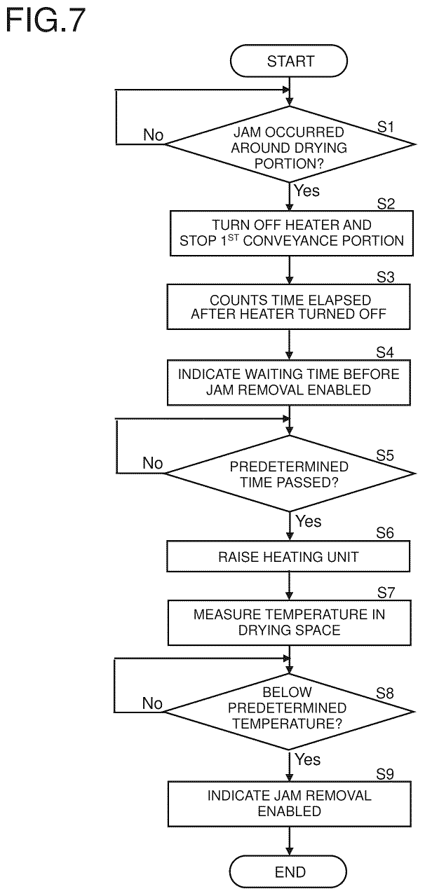

FIG. 7 is a flow chart showing an example of control including the operation of raising the heating unit 41 when a sheet P has jammed around the drying portion 40. Referring back to FIGS. 1 to 6 as necessary, the timing of raising the heating unit 41 and the control performed before the jam removal enabled state is established will be described along the steps in FIG. 7.

First, the control portion 90 checks whether a jam of a sheet P has occurred around the drying portion 40 (Step S1). Here, “a jam of a sheet P around the drying portion 40” refers to a state where a jam of a sheet P has occurred between the heating unit 41 and the first conveyance portion 20 (the conveyance belt 22) and where the heating unit 41 needs to be raised to the retracted position.

If a jam of a sheet P occurs around the drying portion 40 (Yes in Step S1), the control portion 90 transmits a control signal to the voltage control circuit 84 to turn off the supply of power from the heater voltage power supply 86 to the heater 43 and, at the same time, stop the first conveyance portion 20 (conveyance belt 22) (Step S2).

Next, the control portion 90 counts with a timer 75 the time elapsed after the supply of power to the heater 43 was turned off (Step S3). It also indicates on the liquid crystal display portion 81 the waiting time (estimated remaining time) before the jam removal enabled state is established (Step S4). The “jam removal enabled state” refers to a state where, after the heating unit 41 has raised to the retracted position, the temperature in the drying space between the heating unit 41 and the conveyance belt 22 has fallen below a predetermined temperature (the second temperature, for example, 40° C.).

Next, the control portion 90 checks whether a predetermined time (for example, 30 seconds) has passed after the supply of power to the heater 43 was turned off (Step S5). If the predetermined time has passed (Yes in Step S5), the control portion 90 transmits a control signal to the unit ascent-decent mechanism 87 to raise the heating unit 41 to the retraction position (see FIG. 6) (Step S6).

Next, with the drying portion temperature sensor 83, the control portion 90 measures the temperature in the drying space (Step S7). Then, the control portion 90 then checks whether the temperature in the drying space has fallen below the predetermined temperature (for example, 40° C.) is checked (Step S8). If the temperature has fallen below the predetermined temperature (Yes in Step S8), the control portion 90 indicates on the liquid crystal display portion 81 that the jam removal enabled state is established (Step S9) and ends the procedure.

With the configuration according to this embodiment, if a jam of a sheet P occurs around the drying portion 40, after the supply of power to the heater 43 is turned off, at the lapse of a predetermined period of time, the heating unit 41 is raised to the retraction position. Thus, the heating unit 41 is raised in a state where the temperature of the heating unit 41 has fallen below the first temperature, and this helps prevent the hot air present between the heating unit 41 and the conveyance belt 22 dispersing inside the sheet drying apparatus 10. It is thus possible to effectively prevent electronic components such as the second sheet detection sensor 65 and the third sheet detection sensor 66 located near the drying portion 40 from deteriorating due to heat.

After the heating unit 41 is raised to the retracted position and the temperature in the drying space has fallen below the second temperature, the user is notified that the jam removal enabled state is established. This reliably prevents the user from inserting his or her hand into the hot drying space and suffering a burn. Setting the second temperature lower (for example, 40° C.) than the first temperature leads to higher safety during jam removal for the sheet P.

Moreover, when a jam of a sheet P occurs, the waiting time (estimated remaining time) before the jam removal enabled state is established is indicated on the liquid crystal display portion 81. This permits the user to grasp the waiting time before the jam removal enabled state is established and helps enhance convenience. In addition to the waiting time, the current temperature or a warning prohibiting jam removal may also be indicated.

In the example of control shown in FIG. 7, with the supply of power to the heater 43 turned off, a wait is provided until the temperature of the heating unit 41 falls to the first temperature and then another wait is provided until the temperature in the drying space falls to the second temperature. Instead of this configuration, the temperatures of the heating unit 41 and in the drying space can be forcibly lowered.

For example, after a jam occurs, the suction fan 51 (see FIG. 1) in the suction fan unit 50 may be kept being driven. Thus, the hot air present in the drying space is discharged via the first and second ducts 53 and 54 (see FIG. 1 for both) out through the exhausting port 60. That is, the suction fan unit 50 and the first and second ducts 53 and 54 are used as a heat dissipation device.

Or, the ambient air intake fans 63 (see FIG. 1) may be arranged at a position where it can take the ambient air into the heating unit 41 or the drying space and the ambient air intake fans 63 may be driven after a jam occurs. Thus, the heating unit 41 and the drying space are cooled with the ambient air. That is, the ambient air intake fans 63 are used as a cooling device.

When a jam occurs, driving at least one of the suction fan unit 50 and the ambient air intake fans 63 helps promote the fall of the temperatures of the heating unit 41 and in the drying space and helps reduce the waiting time before the jam removal enabled state is established.

In the example of control shown in FIG. 7, after the supply of power to the heater 43 is turned off, with the lapse of a predetermined time, the temperature of the heating unit 41 is estimated to have fallen to the first temperature. Instead a temperature sensor may be used to sense the temperature of the heating unit 41 having fallen to the first temperature.

Note however that, it is preferable to check whether the temperature in the drying space has fallen to the second temperature not with the lapse of a predetermined time but, from the viewpoint of safety, based on the result of sensing by the drying portion temperature sensor 83.

The present disclosure can be implemented in any manner other than as in the embodiment described above, and allows for any modifications without departure from the spirit of the present disclosure. For example, in the embodiment described above, a jam is detected based on the timing of detection of the sheet P at the second and third sheet detection sensors 65 and 66; instead, the second and third sheet detection sensors 65 and 66 can be omitted, in which case a jam may be detected based on the timing of detection of the sheet P at the first and fourth sheet detection sensors 64 and 67.

While the embodiment described above deals with, as an example of the image forming system 200, a configuration where the sheet drying apparatus 10 is coupled to an inkjet printer as an image forming apparatus 100, needless to say, the sheet drying apparatus 10 can be used independently without being coupled to the image forming apparatus 100.

The present disclosure finds applications in sheet drying apparatuses that dry sheets on which images have been printed in inkjet recording apparatuses and the like. Based on the present disclosure, it is possible to provide a sheet drying apparatus that can prevent electronic components from deteriorating due to heat caused by hot air dispersed inside the sheet drying apparatus during jam removal in a drying portion, and to provide an image forming system provided with such a sheet drying apparatus.

What is claimed is:

1. A sheet drying apparatus comprising:
a conveyance portion that conveys a sheet on which an image has been formed with ink containing moisture;
a drying portion arranged opposite the conveyance portion, the drying portion heating and drying the sheet; and
a control portion that controls the conveyance portion and the drying portion,
wherein
the drying portion includes:
a heating unit having a heater for heating the sheet, the heating unit being capable of being raised and lowered between a heating position in which the heating unit heats the sheet with the heater and a retracted position in which the heating unit is arranged away from the conveyance portion, and
a unit ascent-descent mechanism that raises and lowers the heating unit,
wherein
when a jam of the sheet is detected between the conveyance portion and the heating unit,
the control portion turns off supply of power to the heater to stop the conveyance portion, and
the control portion arranges the heating unit at the heating position until a temperature in the heating unit falls below a first temperature and, after the temperature in the heating unit falls below the first temperature, the control portion raises the heating unit from the heating position to the retraction position with the unit ascent-descent mechanism.

2. The sheet drying apparatus according to claim 1, wherein
based on a time elapsed after the supply of power to the heater was turned off, the control portion estimates that the temperature of the heating unit has fallen below the first temperature.

3. The sheet drying apparatus according to claim 1, wherein
after the heating unit is raised from the heating position to the retracted position, until a temperature in a drying space between the heating unit and the conveyance portion falls below a second temperature lower than the first temperature, the control portion prohibits jam removal.

4. The sheet drying apparatus according to claim 3, further comprising:
at least one of a heat dissipation device that dissipates heat of the heating unit or in the drying space and a cooling device that cools the heating unit or the drying space,
wherein
when a jam of the sheet is detected between the conveyance portion and the heating unit, the control portion forcibly lowers the temperature of the heating unit or in the drying space by driving the heat dissipation device or the cooling device.

5. The sheet drying apparatus according to claim 4, wherein
the heat dissipation device is configured with a duct and a suction fan unit for sucking in and discharging air in the drying space.

6. The sheet drying apparatus according to claim 4, wherein
the cooling device is an ambient air intake fan that takes ambient air into the heating unit or the drying space.

7. The sheet drying apparatus according to claim 3, further comprising:
a notification portion that can indicate a jam removal enabled state in which jam removal can be performed for the sheet,
wherein
after the temperature in the drying space has fallen below the second temperature, the control portion indicates using the notification portion that the jam removal enabled state is established.

8. The sheet drying apparatus according to claim 7, wherein
the control portion indicates using the notification portion at least one of a waiting time before the jam removal enabled state is established and the temperature in the drying space.

9. An image forming system comprising:
an image forming apparatus that forms an image on a sheet with ink containing moisture; and
the sheet drying apparatus according to claim 1 that is coupled to the image forming apparatus at a downstream side thereof in a conveyance direction of the sheet.
